(19) United States
(12) Patent Application Publication
(10) Pub. No.: US 2010/0024278 A1
(43) Pub. Date: Feb. 4, 2010

(54) METHODS AND DEVICES FOR ATTRACTING AND TRAPPING INSECTS

(75) Inventors: Miri Simchoni-Barak, Yiftach (IL); Yosef Schlein, Jerusalem (IL); Gunter Muller, Freising (ID)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: WESTHAM LTD., Tel Aviv (IL)

(21) Appl. No.: 12/526,051

(22) PCT Filed: Feb. 5, 2008
(86) PCT No.: PCT/IL2008/000157

§ 371 Date: Aug. 6, 2009

Related U.S. Application Data
(60) Provisional application No. 60/888,563, filed on Feb. 7, 2007.

(51) Int. Cl. A01M 1/04; A01M 1/00; A01M 1/14

(52) U.S. Cl. 43/113; 43/107; 43/114

(57) ABSTRACT

Trapping devices for biting and nuisance flies, and fleas are disclosed. Device optionally include: a trap housing; a trapping surface, positioned in the trap housing, for trapping insects, the trapping surface having an exposed sticky side; a light-emission module, positioned in the trapping surface, having at least one LED light source; a light-transmitting casing for covering the light-emission module, a heating film for emitting heat in a vicinity of the trapping surface, an attractant compartment in the trap housing; an attractant drawer configured to be inserted into the attractant compartment, and configured to hold at least one insect attractant; and at least one attractant-dispersant aperture configured to emit at least one insect attractant in front of the trapping surface. Other disclosed devices include a trapping ramp for catching fleas, and a shadow mode for enhancing insect attraction. Other disclosed devices include an attractant combined with a sticky sheet.

### FIELD AND BACKGROUND OF THE INVENTION

The present invention relates to insect-trapping devices for attracting and trapping insects, including flying insects such as biting flies (e.g. mosquitoes, sand flies, and biting midges) and nuisance flies (e.g. house flies, filth flies, fruit flies), and non-flying insects (e.g. fleas).

Biting and nuisance flies and fleas are major pests because of their troublesome behavior, and the irritation they cause by biting. Furthermore, some species are carriers of various human and animal diseases. Current control methods for these insects include: repellents, source reduction by removal and/or modification of breeding habitats, the use of pesticides to reduce larval and adult populations, and removing adults by trapping devices and toxic bait stations.

It would be desirable to have more effective insect-trapping devices for attracting and trapping biting flies, nuisance flies, and fleas.

### SUMMARY OF THE INVENTION

It is the purpose of the present invention to provide insect-trapping devices for attracting and trapping biting and nuisance flies and fleas. Specifically, insect-trapping devices utilizing a multi-sensory approach to attract the insects toward the device including: visual attraction (via shape, color, and light patterns), heat, and/or chemical attractants based on food substances.

The present invention discloses insect-trapping devices having several configurations. Preferred embodiments of the present invention include an apparatus for outdoor use and an apparatus for indoor use. Such indoor use includes homes, hotels, hospitals, food outlets, and more generally the interior and exterior of any space where it is desired to remove insects in the space. To attract the insects, two or more complementary senses (e.g. smell, sight, and taste) are used.

According to the present invention there is provided a system for attracting and catching insects, especially biting and nuisance flies and fleas. The system features improved attracting/catching capability and attractant dissipation. The combination of the features mentioned is important as there are numerous known parameters which are synergistic in attracting and catching biting and nuisance flies and fleas.

Therefore, according to the present invention, there is provided for the first time an insect-trapping device for catching biting and nuisance flies, the device including: (a) a trap housing; (b) a trapping surface, positioned in the trap housing, for trapping insects, the trapping surface having an exposed sticky side; (c) a light-emission module, positioned in the trapping surface, having at least one LED light source; and (d) a light-transmitting casing for covering the light-emission module.

Preferably, the trap housing and the trapping surface are configured to be a visual attractant for the insects using alternating dark and light color-patterns on a three-dimensional shape.

Preferably, the trap housing has a light color, and wherein the trapping surface has a dark color and a concave shape.

Preferably, the light-transmitting casing is configured to have a surface finish selected from the group consisting of: a clear finish, a milky finish, a stained finish, a clear/sand-blasted finish, and a clear/stained finish.

Preferably, the device further includes: (e) a heating film for emitting heat in a vicinity of the trapping surface.

Most preferably, the heating film is configured to produce a heating pattern having at least two strips.

More preferably, the device further includes: (f) an attractant compartment in the trap housing; (g) an attractant drawer configured to be inserted into the attractant compartment, and configured to hold at least one insect attractant; and (h) at least one attractant-dispersant aperture, in the trap housing, configured to emit at least one insect attractant in front of the trapping surface.

More preferably, the trap housing, the trapping surface, the light-emission module, the heating film, at least one attractant-dispersant aperture, and the attractant drawer, having at least one insect attractant residing therein, are operative to synergistically effect an attraction of the insects toward the device.

Most preferably, at least one insect attractant is at least one type selected from the group consisting of: a liquid form, a dry solid form, a moist solid form, an embedded form, a cartridge form, and a slow-release form.

Preferably, the device further includes: (e) an attractant compartment in the trap housing; (f) an attractant drawer configured to be inserted into the attractant compartment, and configured to hold at least one insect attractant; and (g) at least one attractant-dispersant aperture, in the trap housing, configured to emit at least one insect attractant in front of the trapping surface.

According to the present invention, there is provided for the first time an insect-trapping device for catching fleas, the device including: (a) an upper housing; (b) a lower housing attached to the upper housing, the lower housing including: (i) a trapping ramp for enabling creatures to enter the device; and (ii) a trapping compartment configured to accommodate a trapping element; and (c) a light module having at least one light source and a light sensor, the light module connected to the upper housing; and (d) a flea grid, positioned on the upper housing, configured to protect the trapping compartment from contact with objects other than insects.

Preferably, the upper housing and the lower housing are configured to be folded together for storing the device.

Preferably, at least one light source is configured to be activated and deactivated at various time intervals, and wherein a light-emission profile of at least one light source is operative to mimic movement in a shadow mode.

Preferably, at least one light source is configured to be activated and deactivated based on a signal from the light sensor.

Preferably, the light module includes at least two light sources, wherein at least two light sources are configured to be activated and deactivated at various time intervals in a programmable sequence, and wherein a light-emission profile of at least two light sources is operative to mimic movement in a shadow mode.

Preferably, the device further includes: (e) the trapping element for trapping the insects in the trapping compartment.

More preferably, the trapping element includes at least one element selected from the group consisting of: a trap sticker, a glue board, a water tray, a chemical tray, and an electrical grid.

Most preferably, the trap sticker has at least one grasping tab for handling the trap sticker, and at least one folding line for folding the trap sticker for disposal.

Preferably, the upper housing, the lower housing, and the flea grid are disposable components, and wherein the light module is mounted on a non-disposable trap post adapted to be reversibly attached to the upper housing, the lower housing, and the flea grid.

Preferably, the device includes at least two of an element selected from the group consisting of: the upper housing, the lower housing, and the flea grid.

According to the present invention, there is provided for the first time an insect-trapping device for catching biting flies, the device including: (a) a sticky sheet configured to enable an insect attractant to effuse out of the device.

Preferably, a front side of the sticky sheet, is dark-colored, and wherein a back side of the sticky sheet is light-colored.

Preferably, the device is configured to be securely mounted in a vertically-inclined orientation.

Preferably, the sticky sheet is impregnated with the insect attractant.

Most preferably, the device further includes: (b) a backing sheet, attached to a back side of the sticky sheet, for preventing the insect attractant from effusing out of the back side.

Preferably, the device further includes: (b) an attractant-impregnated board for attached to the sticky sheet.

Most preferably, the sticky sheet is perforated for allowing the insect attractant, from the attractant-impregnated board, to effuse out of a front side of the device.

Most preferably, the sticky sheet has at least one aperture for exposing a portion of the attractant-impregnated board.

Most preferably, the attractant-impregnated board has at least one elevation insert for separating the sticky sheet from the attractant-impregnated board in order to allow the insect attractant to effuse out of a front side of the device.

More preferably, the device further includes: (c) a backing sheet, attached to a board back side of the attractant-impregnated board, for preventing the insect attractant from effusing out of the board back side.

Most preferably, a front side of the sticky sheet is dark-colored, and wherein a sheet back side of the backing sheet is light-colored.

Most preferably, the device is configured to be mounted in a container having a removable sheet cover.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1A shows an isometric view of the front of a mosquito and fly trap for catching insects, in particular mosquitoes and flies, according to preferred embodiments of the present invention;

FIG. 1B shows an isometric view of the back of the trap of FIG. 1A;

FIG. 2A shows an isometric view of the front of an insect FleaTrap for catching insects in an open configuration, in particular adult fleas and their larvae, according to preferred embodiments of the present invention;

FIG. 2B shows an isometric view of the FleaTrap of FIG. 2A in a closed configuration and a FleaTrap sticker, according to preferred embodiments of the present invention;

FIG. 2C shows a side view of the FleaTrap of FIG. 2B;

FIG. 3A shows a front view of the light-emission profiles created by the FleaTrap of FIG. 2A;

FIG. 3B shows a top view of the light-emission profiles created by the FleaTrap of FIG. 2A;

FIG. 3C shows a side view of the light-emission profiles created by the FleaTrap of FIG. 2A;

FIG. 4A shows an isometric view of the front of a semi-disposable insect FleaTrap for catching insects, in particular adult fleas and their larvae, according to preferred embodiments of the present invention;

FIG. 4B shows an isometric view of the back of the semi-disposable FleaTrap of FIG. 4A;

FIG. 5A shows an exploded view, revealing the components, of an insect/mosquito sticker (Mosticker) for catching insects, in particular mosquitoes and other biting flies, according to preferred embodiments of the present invention;

FIG. 5B shows an isometric view of the Mosticker of FIG. 5A when fully-assembled.

### DESCRIPTION OF THE PREFERRED EMBODIMENTS

The present invention relates to insect-trapping devices utilizing a multi-sensory approach to attract the insects toward the device including: visual attraction (via shape, color, and light patterns), heat, and/or chemical attractants. The principles and operation for such insect-trapping devices, according to the present invention, may be better understood with reference to the accompanying description and the drawings.

Before describing embodiments of the present invention in detail, it is to be understood that the present invention is not limited in its application to the details of configuration and arrangement of the components set forth in the following description or shown in the accompanying drawings. Exemplary embodiments that are described herein are not to be construed as limiting with regard to, among other things, size, shape, material, and/or construction.

### Insect EuroTrap

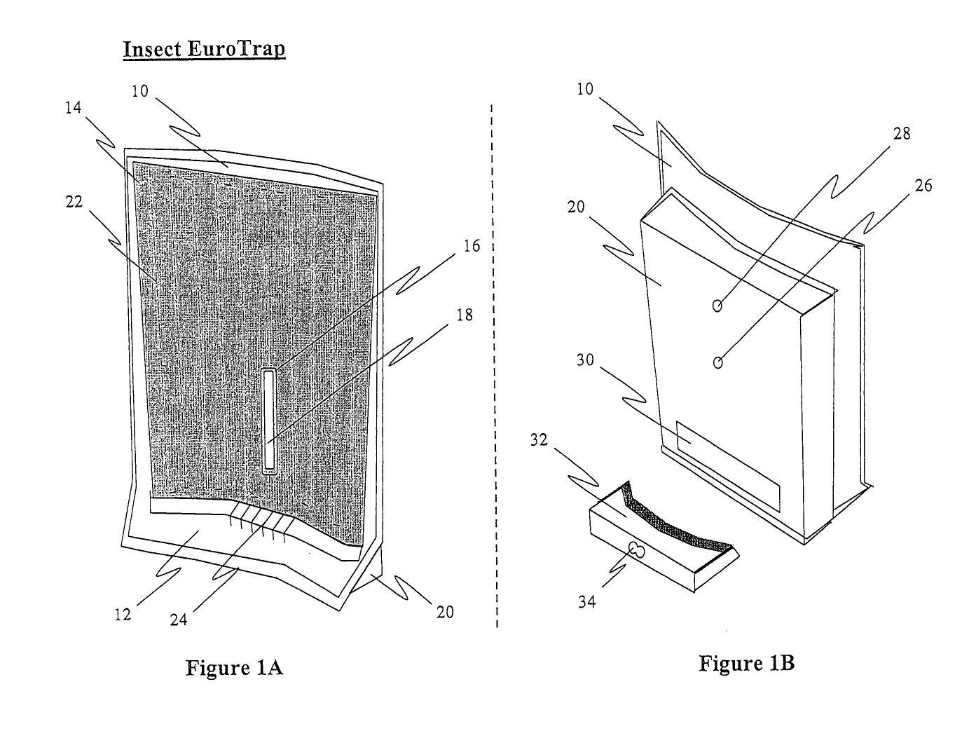

Referring now to the drawings, FIG. 1A shows an isometric view of the front of a mosquito and fly trap for catching insects, in particular mosquitoes and flies, according to preferred embodiments of the present invention. An insect EuroTrap 10 is shown having a frame base 12. A trapping surface 14 (preferably a concave-shaped, dark-colored heated surface) is shown in the center of EuroTrap 10. Trapping surface 14 has a sticky exterior side for trapping insects, and may have various shapes (e.g. elliptical or square). The concave shape of trapping surface 14 provides greater attracting performance than flat or convex surfaces.

Located in trapping surface 14 is a light-emission module 16. Light-emission module 16 includes one or more LED light sources, having similar or different wavelengths, embedded in a light-transmitting casing 18 (e.g. Perspex block) for diffusing the light of the LEDs (with or without a reflector on the back side of light-emission module 16. Depending on the wavelength and the wattage of the light sources in light-emission module 16, light-emission module 16 is used as an attractant to various insects (including mosquitoes, sand flies, and house flies). A rear housing 20 is also shown in FIG. 1A. The best overall results for attracting biting and nuisance flies are obtained using UV LEDs in light-emission module 16; nevertheless, certain genera of flies may be attracted more effectively with other visible wavelengths of light (e.g. green, yellow, and red).

The configuration of light-emission module 16 is superior to open LEDs, LEDs with reflectors, incandescent lights, and UV tubes for attracting mosquitoes and sand flies in an indoor and outdoor environment. LEDs can be embedded in light-transmitting casing 18 in the form of a plate, cube, or column, for example. For best performance, the thickness of the exposed side of light-transmitting casing 18, through which light is transmitted, should be about 1-15 mm. The exposed side of light-transmitting casing 18 can be various surface finishes (e.g. clear, milky, stained, clear with a sand-blasted surface, and clear with a stained surface).

Colors and color patterns, as well as specific shapes and combinations of these features, can act as an attractant or repellent for many insects. These features are critical for the overall performance of any trap or device to catch insects in general, and mosquitoes, sand flies, and house flies in particular. It is noted that frame base 12 preferably has a light-colored appearance in order to enhance the contrast in color with trapping surface 14, thereby enhancing the visual-attraction effect. To focus the attraction of insects to trapping surface 14, rear housing 20 preferably has a light-colored appearance as well.

The configuration of EuroTrap 10 combining the concave shape and the coloring and patterning of the trap is highly significant in enhancing performance, relative to other trap configurations, for attracting both blood-sucking and house flies. Embodiments of the present invention can enhance the performance of traditional insect traps (e.g. electric insect zappers) as well.

In preferred embodiments of the present invention, the configuration of EuroTrap 10 is especially effective when a combination of attractants (e.g. chemical, visual (e.g. color, pattern, and shape), and physical (e.g. heat)) is used. Optionally, trapping surface 14 can be heated by a heating film 22 that transfers the energy to the external environment.

The heating configuration of heating film 22 includes multiple heated strips (e.g. about 1-4 cm between each strip), making sure to have sufficient heat, as well as a unique, fluctuating heating pattern with a temperature gradient from 45° C. to ambient room temperatures. The maximum temperature on the surface of EuroTrap 10 is about 45° C. The optimum temperature to attract blood-sucking flies is between 35-45° C. while house (and filth) flies prefer lower temperatures, typically slightly above the ambient temperature.

The requirements for such a controlled and patterned heating arrangement comes from the need to imitate the body-heat pattern of warm-blooded prey for biting flies (e.g. about 37-44° C.), as well as the heating patterns emitted by rotting organic matter (e.g. several degrees above ambient temperature) for house and filth flies.

In preferred embodiments of the present invention, attractant-dispersant apertures 24, shown in FIG. 1A, is used to attract insects by dispersing optional attractants in the vicinity of EuroTrap 10. The configuration of attractants, including chemical lures, in an insect trap is highly significant for providing enhanced performance in trapping insects. The relative positions of the attractants, as well as the manner in which the attractants are released, directly influence the dispersal of the attractants. An optimal dispersal, having a continuous and even release of attractant, provides enhanced performance.

FIG. 1B shows an isometric view of the back of the trap of FIG. 1A. EuroTrap 10 includes an electronic board (not shown in FIG. 1B) for controlling all electrical functions of EuroTrap 10 including current regulation and temperature control, for example. A power socket 26 is shown in FIG. 1B as well as a mounting aperture 28.

In preferred embodiments of the present invention, an attractant compartment 30 is provided in EuroTrap 10 for inserting an attractant drawer 32 which optionally contains attractants. The configuration of the shape of EuroTrap 10 in combination with attractant-dispersant apertures 24, attractant compartment 30, and attractant drawer 32 provides an attractant release rate for optimal insect attraction, while providing a desired operation time in which the attractant is effective.

The configuration of attractant drawer 32 in Euro-Trap 10 allows for easy maintenance without interfering with the sticky side of trapping surface 14. Drawer removal is aided by a drawer handle 34. The dispersal of the attractant in the front, lower section of EuroTrap 10, via attractant-dispersant apertures 24, is facilitated by a convectional upwardly-directed air stream when trapping surface 14 is heated via heating film 22. Such an air stream in combination with a chemical lure acts as a strong attractant in a similar way in which a warm, perspiring human body attracts mosquitoes and sand flies. House flies are attracted directly to attractant-dispersant apertures 24, and are trapped while approaching EuroTrap 10.

Attractant drawer 32 may contain different cartridges of attractant combinations. Such cartridges may include attractants in liquid or solid form (either moist or dry). Examples of attractant components include lactic acid, octenol, flower extracts, and fruit extracts. Even water alone will enhance the attraction of mosquitoes due to the presence of moisture. The unique configuration of EuroTrap 10 allows the odors emitted by trapped insects (also a form of attractant) to blend with attractants released from attractant compartment 10. Some trapped insect species, especially house flies before and even after their death, emit attractants through their body. Furthermore, attractant cell 10 serves to isolate insects from the attractants (especially liquid attractants) in order to avoid possible rotting of the trapped insects within the chamber (and by this to avoid producing a foul odor).

In preferred embodiments of the present invention, EuroTrap 10 includes an attractant which may be suitable for all kinds of insects, especially for biting flies (e.g. mosquitoes) and nuisance flies (e.g. house flies). An attractant “cocktail” can be yielded from fermentation processes with different types of yeast. Among these attractants, the most potent ones are lactic acid, acetone, 3-methylbutanol, glutamic acid, tyrosine, lysine, and phenylalanine. These attractants (as well as others not specified here) are collected from the fermentation process (by collecting the emitted gases), and are enriched and embedded in ethanol, aqua dist., or other suitable carriers including all kinds of slow-release substances. The attractants, with the carrier, can be packed in a variety of cartridges to ensure easy handling and long shelf-life. The attractants that are based on food products and processes are also FDA-exempt.

### Insect FleaTrap

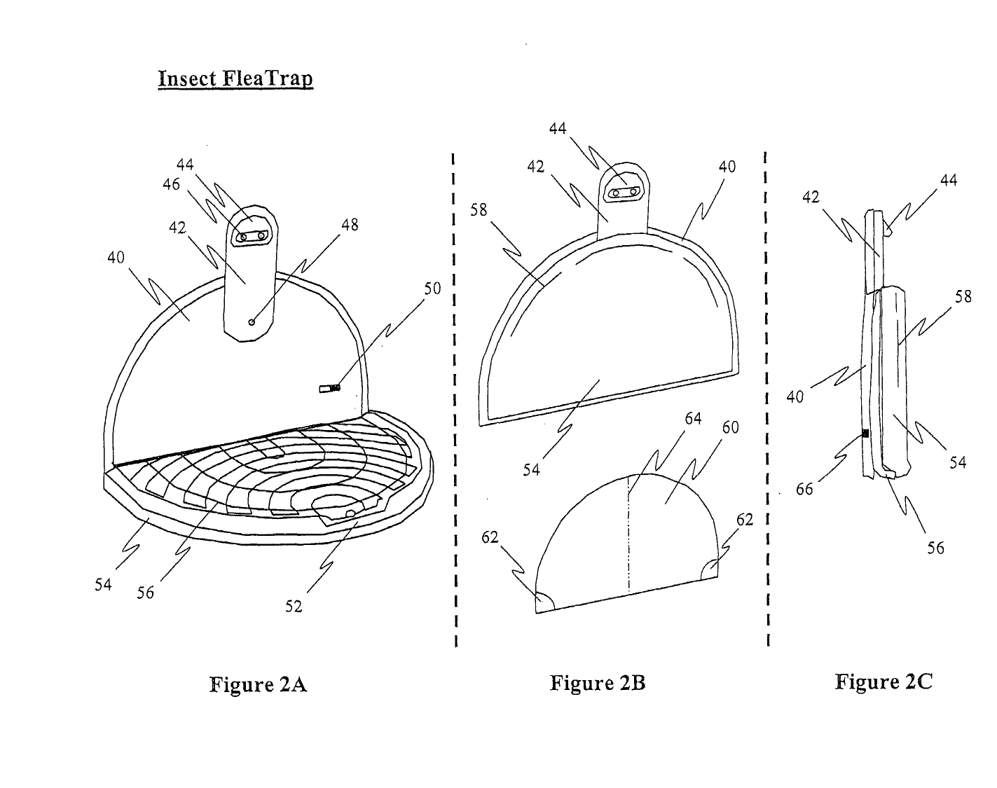

FIG. 2A shows an isometric view of the front of an insect FleaTrap for catching insects in an open configuration, in particular adult fleas and their larvae, according to preferred embodiments of the present invention. A FleaTrap 40 is shown having a light module 42 mounted on an upper housing (indicated in FIG. 2A by FleaTrap 40). Light module 42 includes a light-emitting head 44, having one or more light sources 46, and a light sensor 48. Light sensor 48 is used to determine the ambient light in the environment, and adjust the output of light sources 46 accordingly. A power switch 50 is shown on FleaTrap 40 as well.

Among other things, fleas are attracted by movement of potential prey and their resulting shadows (light/dark contrast). Movements can be mimicked by a single light source 46 (preferably of green color) that is switched on and off at fixed time intervals. For example, in such a single light-source embodiment, light source 46 can be activated for several minutes, and then switched off for several seconds. Once attracted, fleas can then be caught using various methods (e.g. glue boards, water trays, chemical trays, and electrical grids).

In preferred embodiments of the present invention in which more than one light source 46 is implemented, light sources 46 can be activated (i.e. switched on) and deactivated in succession within a short time interval (e.g. milliseconds to several seconds), followed by a longer period of time (e.g. 1 to 10 minutes) in which one or light sources 46 remains lit.

Such a multi-light-source configuration is superior, in attracting fleas, to arrangements employing a single permanent (i.e. always on) or a single alternating (i.e. blinking) light source. If LEDs are used for light sources 46, then wide-angle diodes (or diodes with a dispersion lens) yield better attraction of fleas than narrow-angle diodes. A specific shadow mode can be created by alternating activation of light sources 46 in a synchronous or asynchronous on/off mode.

Flea larvae are attracted to potential prey, and to a certain extent, to the shadow mode created by alternating light sources 46 of FleaTrap 40. Flea larvae are slow crawling creatures, and are not able to jump. Flea larvae are not able to enter traps known in the art. In FIG. 2A, a trapping ramp 52, having an angle of less than 90° at its access point, enables flea larvae to crawl toward the attracting features of FleaTrap 40. Trapping ramp 52 is integrated into a lower housing 54 of FleaTrap 40, providing structural support. Trapping ramp 52 can be either used to bridge the full altitude from the ground to the height of FleaTrap 40, or the access point of trapping ramp 52 can be configured as entrance slits.

Sticky-paper-type traps are problematic when used in the proximity of pets. Animals get easily trapped in unprotected sticky surfaces. Such a situation can be troublesome for the animal as well as damaging to the trap. Delicate grids can easily be broken by pets, while more robust models reduce the flea-trapping ability of the trap. Grids get dirty easily, and are difficult to clean. In addition, users of such traps are bothered by seeing trapped insects on sticky paper. In FIG. 2A, a flea grid 56 is configured to provide maximum mechanical stability, and to keep out undesired objects (e.g. hair of pets) from the trapping element (not shown in FIG. 2A), located under flea grid 56 in the cavity of lower housing 54, while allowing fleas to enter easily without being able to escape.

FIG. 2B shows an isometric view of the FleaTrap of FIG. 2A in a closed configuration and a FleaTrap sticker, according to preferred embodiments of the present invention. FleaTrap 40 has a collapsible configuration in which lower housing 54 can be folded into the upper portion of FleaTrap 40, making FleaTrap 40 compact, protected, and safe for storing. Ventilation apertures 58 prevent the accumulation of odor from FleaTrap 40 when closed for extended periods of time. FIG. 2C shows a side view of the FleaTrap of FIG. 2B. A power socket 66 is used to connect power to FleaTrap 40.

Sticky paper and glue boards are usually problematic to handle. In FIG. 2B, a FleaTrap sticker 60 is also shown. FleaTrap sticker 60 has grasping tabs 62, which are free of adhesive, for enabling FleaTrap sticker 60 to be inserted into and removed from lower housing 54 under flea grid 56 cleanly and easily, without reducing the trapping capabilities of FleaTrap sticker 60. A folding line 64 in the middle of FleaTrap sticker 60 allows a user to fold up FleaTrap sticker 60 after being used, thereby covering the trapped fleas and the sticky surface, and allowing easy and clean disposal.

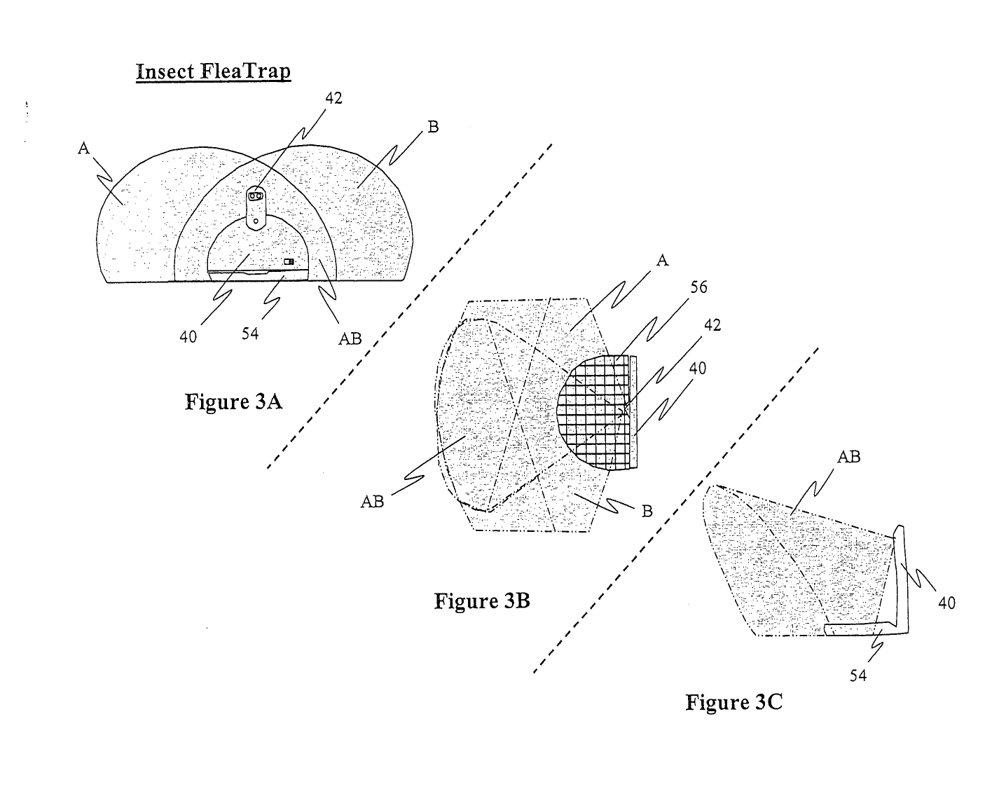

FIG. 3A shows a front view of the light-emission profiles created by the FleaTrap of FIG. 2A. In the exemplary embodiment, light-emission profiles generated by two light sources 46 are shown. Light-emission profiles A and B are generated by light sources 46. A resulting light-emission profile AB, representing the composite profile from profiles A and B, is also shown. FIG. 3B shows a top view of the light-emission profiles created by the FleaTrap of FIG. 2A. FIG. 3C shows a side view of the light-emission profiles created by the FleaTrap of FIG. 2A.

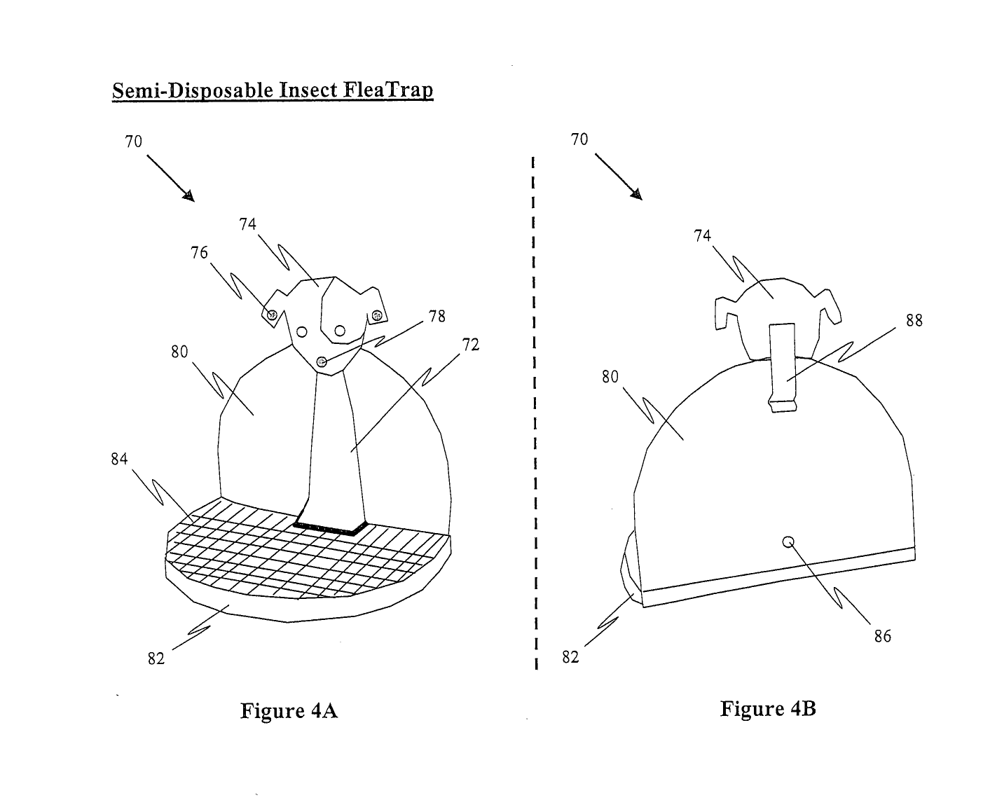

Insect traps are typically cumbersome to store, and can easily be damaged. In addition, many users dislike handling dead insects on sticky paper and servicing insect traps. FIG. 4A shows an isometric view of the front of a semi-disposable insect FleaTrap for catching insects, in particular adult fleas and their larvae, according to preferred embodiments of the present invention. A semi-disposable FleaTrap 70 includes a non-disposable trap post 72. Trap post 72 includes a light module 74 having one or more light sources 76 and a light sensor 78. While the exemplary embodiment of FIG. 4A depicts light module 74 in the shape of a dog's head, it is understood that various embodiments for light module 74, as well as other components of FleaTrap 70, are included within the context of the present invention.

A disposable upper panel 80 and a lower panel 82 are shown attached to trap post 72. A disposable grid and glue-board assembly 84 is shown residing in lower panel 82. Such a configuration makes it easy to dispose used traps containing trapped fleas without a long handling time, and without touching any sticky surfaces containing trapped fleas. When FleaTrap 70 is ready to be discarded, trap post 72 is removed, and upper panel 80 and lower panel 82 are folded together to secure grid and glue-board assembly 84 inside, enabling clean and easy disposal or storage.

FIG. 4B shows an isometric view of the back of the semi-disposable FleaTrap of FIG. 4A. A power socket 86 is located in the back of trap post 72. A corresponding aperture in upper portion 80 allows power to be connected to FleaTrap 70 via power socket 86. A support fastener 88 enables upper portion 80 to be securely attached to trap post 72.

### Insect/Mosquito Sticker (Mosticker)

Mosquitoes and sand flies are attracted to objects having dark colors and certain scents (e.g. octenol, lactic acid, and ammonia). While dark sticky paper is used widely in the art, so far there is no trap incorporating a sticky paper either directly impregnated with an attractant and/or a sticky paper directly attached to a chemical lure to catch mosquitoes and sand flies.

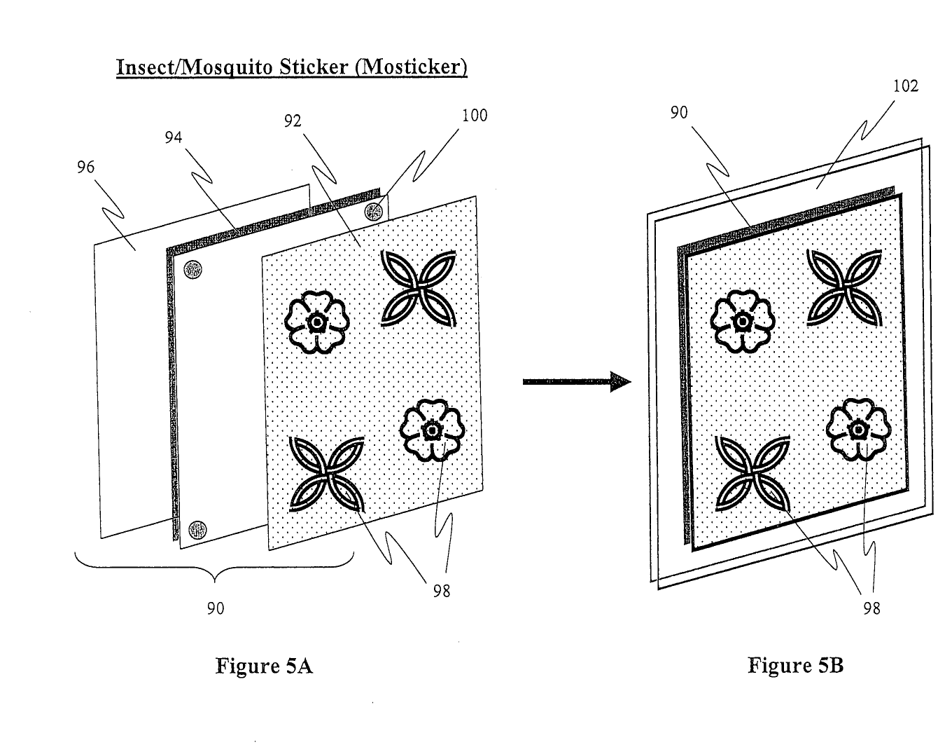

FIG. 5A shows an exploded view, revealing the components, of an insect/mosquito sticker (Mosticker) for catching insects, in particular mosquitoes and other biting flies, according to preferred embodiments of the present invention. A Mosticker 90 (preferably having a dark color) is shown including a sticky sheet 92, an attractant-impregnated board 94, and optionally, a backing sheet 96. Attractant-impregnated board 94 is suitably chosen to have a slow, even release rate for the attractant. Optional backing sheet 96 is used to prevent the attractant from effusing out the back side of Mosticker 90.

Alternatively, sticky sheet 92 can be impregnated with an attractant directly, eliminating the need for attractant-impregnated board 94. Mosticker 90 is an extremely compact trap that is easy to apply, and is superior in its catching ability to sticky paper that does not utilize an attractant. FIG. 5B shows an isometric view of the Mosticker of FIG. 5A when fully-assembled.

In preferred embodiments of the present invention, the attractant effuses through apertures 98 in sticky sheet 92. Alternatively, sticky sheet 92 may be perforated to allow the attractant to effuse out the front of Mosticker 90. In other preferred embodiments, attractant-impregnated board 94 is separated (e.g. several millimeters) from sticky sheet 92 by elevation inserts 100 to allow for better effusion of attractant from the front of Mosticker 90.

Preferred embodiments of the present invention are of general use and can be applied to all kind of sticky paper and attractants that are suitable for blood-sucking flies. As such, Mosticker 90 can be used independently or in combination with other known non-chemical attractants (e.g. moisture, color, pattern, shapes, light, and heat).

In preferred embodiments of the present invention, Mosticker 90 can reside in an optional container 102 (as shown in FIG. 5B) having a reversibly exposable region for sticky sheet 92 using a removable sheet cover (not shown in FIG. 5B). Container 102 eliminates the need for the user to handle Mosticker 90 directly, preventing contact with sticky sheet 92 and any trapped insects therein. The sheet cover enables Mosticker 90 to be closed for storage, when not in use, and to be closed for disposal, preventing any trapped insects from leaving Container 102.

While the invention has been described with respect to a limited number of embodiments, it will be appreciated that many variations, modifications, and other applications of the invention may be made.

What is claimed is:

1. An insect-trapping device for catching biting and nuisance flies, the device comprising:
(a) a trap housing;
(b) a trapping surface, positioned in said trap housing, for trapping insects, said trapping surface having an exposed sticky side;
(c) a light-emission module, positioned in said trapping surface, having at least one LED light source; and
(d) a light-transmitting casing for covering said light-emission module.

2. The device of claim 1, wherein said trap housing and said trapping surface are configured to be a visual attractant for said insects using alternating dark and light color-patterns on a three-dimensional shape.

3. The device of claim 1, wherein said trap housing has a light color, and wherein said trapping surface has a dark color and a concave shape.

4. The device of claim 1, wherein said light-transmitting casing is configured to have a surface finish selected from the group consisting of: a clear finish, a milky finish, a stained finish, a clear/sand-blasted finish, and a clear/stained finish.

5. The device of claim 1, the device further comprising:
(e) a heating film for emitting heat in a vicinity of said trapping surface.

6. The device of claim 5, wherein said heating film is configured to produce a heating pattern having at least two strips.

7. The device of claim 5, the device further comprising:
(f) an attractant compartment in said trap housing;
(g) an attractant drawer configured to be inserted into said attractant compartment, and configured to hold at least one insect attractant; and
(h) at least one attractant-dispersant aperture, in said trap housing, configured to emit said at least one insect attractant in front of said trapping surface.

8. The device of claim 7, wherein said trap housing, said trapping surface, said light-emission module, said heating film, said at least one attractant-dispersant aperture, and said attractant drawer, having said at least one insect attractant residing therein, are operative to synergistically effect an attraction of said insects toward the device.

9. The device of claim 8, wherein said at least one insect attractant is at least one type selected from the group consisting of: a liquid form, a dry solid form, a moist solid form, an embedded form, a cartridge form, and a slow-release form.

10. The device of claim 1, the device further comprising:
(e) an attractant compartment in said trap housing;
(f) an attractant drawer configured to be inserted into said attractant compartment, and configured to hold at least one insect attractant; and
(g) at least one attractant-dispersant aperture, in said trap housing, configured to emit said at least one insect attractant in front of said trapping surface.

11. An insect-trapping device for catching fleas, the device comprising:
(a) an upper housing;
(b) a lower housing attached to said upper housing, said lower housing including:
(i) a trapping ramp for enabling creatures to enter the device; and
(ii) a trapping compartment configured to accommodate a trapping element; and
(c) a light module having at least one light source and a light sensor, said light module connected to said upper housing; and
(d) a flea grid, positioned on said upper housing, configured to protect said trapping compartment from contact with objects other than insects.

12. The device of claim 11, wherein said upper housing and said lower housing are configured to be folded together for storing the device.

13. The device of claim 11, wherein said at least one light source is configured to be activated and deactivated at various time intervals, and wherein a light-emission profile of said at least one light source is operative to mimic movement in a shadow mode.

14. The device of claim 11, wherein said at least one light source is configured to be activated and deactivated based on a signal from said light sensor.

15. The device of claim 11, wherein said light module includes at least two light sources, wherein said at least two light sources are configured to be activated and deactivated at various time intervals in a programmable sequence, and wherein a light-emission profile of said at least two light sources is operative to mimic movement in a shadow mode.

16. The device of claim 11, the device further comprising:
(e) said trapping element for trapping said insects in said trapping compartment.

17. The device of claim 16, wherein said trapping element includes at least one element selected from the group consisting of: a trap sticker, a glue board, a water tray, a chemical tray, and an electrical grid.

18. The device of claim 17, wherein said trap sticker has at least one grasping tab for handling said trap sticker, and at least one folding line for folding said trap sticker for disposal.

19. The device of claim 11, wherein said upper housing, said lower housing, and said flea grid are disposable components, and wherein said light module is mounted on a non-disposable trap post adapted to be reversibly attached to said upper housing, said lower housing, and said flea grid.

20. The device of claim 11, wherein the device includes at least two of an element selected from the group consisting of: said upper housing, said lower housing, and said flea grid.

21. An insect-trapping device for catching biting flies, the device comprising:
(a) a sticky sheet configured to enable an insect attractant to effuse out of the device.

22. The device of claim 21, wherein said sticky sheet is impregnated with said insect attractant.

23. The device of claim 22, the device further comprising:
(b) a backing sheet, attached to a back side of said sticky sheet, for preventing said insect attractant from effusing out of said back side.

24. The device of claim 21, the device further comprising:
(b) an attractant-impregnated board for attached to said sticky sheet.

25. The device of claim 24, wherein said sticky sheet is perforated for allowing said insect attractant, from said attractant-impregnated board, to effuse out of a front side of the device.

26. The device of claim 24, wherein said sticky sheet has at least one aperture for exposing a portion of said attractant-impregnated board.

27. The device of claim 24, wherein said attractant-impregnated board has at least one elevation insert for separating said sticky sheet from said attractant-impregnated board in order to allow said insect attractant to effuse out of a front side of the device.

28. The device of claim 24, the device further comprising:
(c) a backing sheet, attached to a board back side of said attractant-impregnated board, for preventing said insect attractant from effusing out of said board back side.

29. The device of claim 28, wherein a front side of said sticky sheet is dark-colored, and wherein a sheet back side of said backing sheet is light-colored.

30. The device of claim 28, wherein the device is configured to be mounted in a container having a removable sheet cover.

31. The device of claim 21, wherein a front side of said sticky sheet is dark-colored, and wherein a back side of said sticky sheet is light-colored.

32. The device of claim 21, wherein the device is configured to be securely mounted in a vertically-inclined orientation.
